(19) United States
(12) Patent Application Publication
(10) Pub. No.: US 2009/0158547 A1
(43) Pub. Date: Jun. 25, 2009

(54) WIPER BLADE ASSEMBLY HAVING MULTI-BEAM

(75) Inventor: Tae Kyeong KIM, Daegu (KR)

Correspondence Address: EDWARDS ANGELL PALMER & DODGE LLP, P.O. BOX 55874, BOSTON, MA, 02205, US

(73) Assignee: KCW CORPORATION, Daegu (KR)

(21) Appl. No.: 12/028,886

(22) Filed: Feb. 11, 2008

(30) Foreign Application Priority Data
Dec. 20, 2007 (KR) 10-2007-0134382

(51) Int. Cl. B60S 1/04

(52) U.S. Cl. 15/250.351

(57) ABSTRACT

The present invention relates to a wiper blade assembly for wiping a windshield of a vehicle by the activation of a wiper arm, and the wiper blade assembly includes: a flexible elongated wiper blade having a given elastic force and adapted to come into direct contact with the windshield of the vehicle; a pair of rail springs coupled along the sides of the wiper blade so as to maintain the wiper blade in a predetermined shape; a guide beam coupled to the wiper blade and the rail springs to transfer the load and motion applied from the wiper arm to the wiper blade; and at least one or more auxiliary beams coupled to the guide beam and located in a longitudinal direction of the guide beam between the guide beam and the rail springs.

### CROSS-REFERENCE TO RELATED APPLICATION

This application claims under 35 U.S.C. §119(a) the benefit of Korean Patent Application No. 10-2007-0134382 filed Dec. 20, 2007, the entire contents of which are incorporated herein by reference.

### TECHNICAL FIELD

The present invention relates to a wiper blade assembly for wiping a windshield of a vehicle by the activation of a wiper arm, and more particularly, to a wiper blade assembly that includes a plurality of auxiliary beams each having a given initial curvature and providing a certain elastic force, thereby uniformly distributing the load applied from the wiper arm to the end portions of a wiper blade.

### BACKGROUND ART

A wiper is adapted to come into close contact with the curved windshield of a vehicle so as to remove the foreign materials accumulated on the windshield of the vehicle. There are two methods for allowing the wiper to come into close contact with the curved surface of the windshield of the vehicle. The first method is carried out by distributing the pressing force applied from a wiper arm to the wiper blade, and the second method is carried out by providing an initial curvature to the wiper blade assembly.

Generally, the wiper using the second method is called a flat wiper, and especially, the present invention relates to a flat wiper blade assembly. If the wiper blade assembly has a given elastic force by the formation of an initial curvature thereon, it can be brought into close contact with the windshield of the vehicle, without having an additional structure for distributing the load applied from the wiper arm thereto, such that advantageously, it can be configured simply.

The conventional wiper blade assembly includes a flexible elongated wiper blade having a given elastic force that comes into direct contact with a vehicle windshield, a guide beam coupled to the flexible elongated wiper blade so as to distribute a given elastic force generated by the formation of an initial curvature thereon and the load applied from a wiper arm to the wiper blade, thereby allowing the wiper blade to come into direct contact with the vehicle windshield, and rail springs adapted to maintain the wiper blade in a predetermined shape.

The conventional wiper blade assembly is configured in such a manner that the wiper blade and the guide beam are extended longitudinally and the wiper blade is brought into close contact with the vehicle windshield by means of the elastic force provided by the formation of the initial curvature of the guide beam and the load applied from the wiper arm.

The conventional wiper blade assembly has the guide beam extended in a longitudinal direction of the wiper blade, but the wiper arm is connected to the central portion of the guide beam, such that the load applied from the wiper arm is not distributed uniformly to the guide beam and is applied to only the central portion of the guide beam, which results in the application of relatively small load from the wiper arm to the end portions of the wiper blade.

Therefore, the end portions of the wiper blade do not perform their function effectively such that the wiper blade does not completely come into close contact with the windshield of the vehicle. Thus, if the vehicle windshield has a relatively large curvature, the end portions of the wiper blade have a given distance from a surface of the windshield.

On the other hand, if the guide beam has a relatively large curvature so as to allow the end portions of the wiper blade to come into close contact with the windshield of the vehicle, the stiffness of the guide beam becomes undesirably low such that the region from the central portion to the end portion of the guide beam is spaced apart from the surface of the vehicle windshield. To the contrary, if the stiffness of the guide beam becomes high, the wiper blade does not completely abut against the surface of the windshield.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made in view of the above-mentioned problems occurring in the prior art, and it is an object of the present invention to provide a wiper blade assembly that allows a wiper blade to completely come into close contact with a vehicle windshield having a variety of curvatures.

To accomplish the above object, in one aspect, there is provided a wiper blade assembly for wiping a windshield of a vehicle by the activation of a wiper arm, the wiper blade assembly including: a flexible elongated wiper blade having a given elastic force and adapted to come into direct contact with the windshield of the vehicle; a pair of rail springs coupled along the sides of the wiper blade so as to maintain the wiper blade in a predetermined shape; a guide beam coupled to the wiper blade and the rail springs to transfer the load and motion applied from the wiper arm to the wiper blade; and at least one or more auxiliary beams coupled to the guide beam and located in a longitudinal direction of the guide beam between the guide beam and the rail springs.

Preferably, each of the auxiliary beams has holding portions formed at both end portions thereof, the holding portions being adapted to fixedly hold the rail springs and the wiper blade together.

Preferably, each of the auxiliary beams has a given initial curvature.

Preferably, each of the auxiliary beams may be stepped at both end portions thereof and extended linearly along a middle portion thereof.

Preferably, each of the auxiliary beams is coupled to the guide beam by means of a bolt, riveting, or welding, and otherwise, a yoke is formed on the top portion of each auxiliary beam and a coupling hole is formed correspondingly on the guide beam, such that as the yoke is coupled to the coupling hole, the auxiliary beam is coupled to the guide beam.

On the other hand, each of the auxiliary beams may be made of a plastic material, and at this time, the auxiliary beam further includes an elastic coupling part protruded upwardly and branched radially from the end portion thereof so as to provide a given elastic force therefrom, the elastic coupling part having the upper portion having a larger sectional area than the lower portion thereof.

Other features of the present invention are discussed infra.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view showing a wiper blade assembly according to the present invention;

FIG. 2 is an assembled perspective view showing the wiper blade assembly according to the present invention;

FIG. 3 is a sectional view showing the wiper blade assembly according to the present invention;

FIG. 4 is a side view showing the wiper blade assembly according to the present invention; and

FIGS. 5a to 5c are side views showing examples of the coupling between the auxiliary beam and the guide beam in the wiper blade assembly according to the present invention.

### DETAILED DESCRIPTION

Hereinafter, an explanation of a wiper blade assembly according to a preferred embodiment of the present invention will be given with reference to the attached drawings.

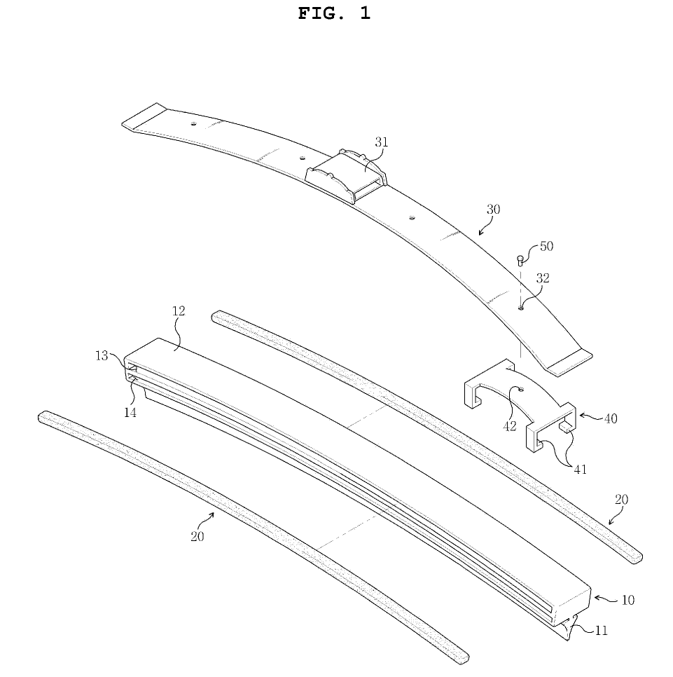

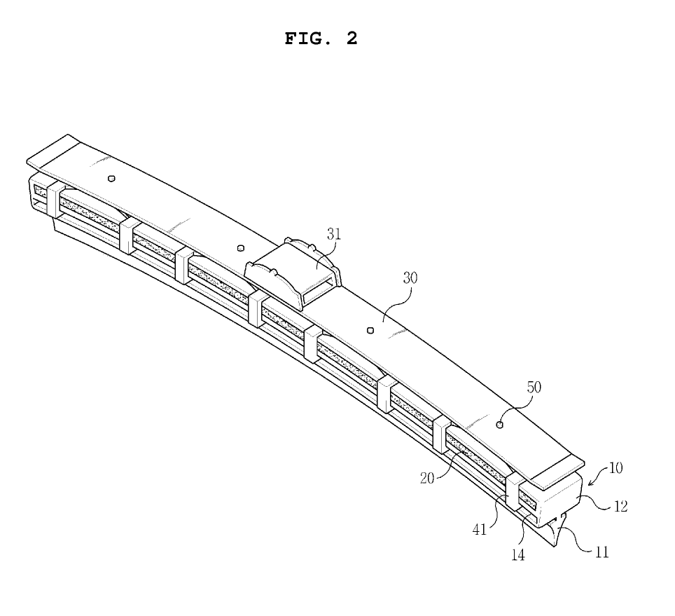

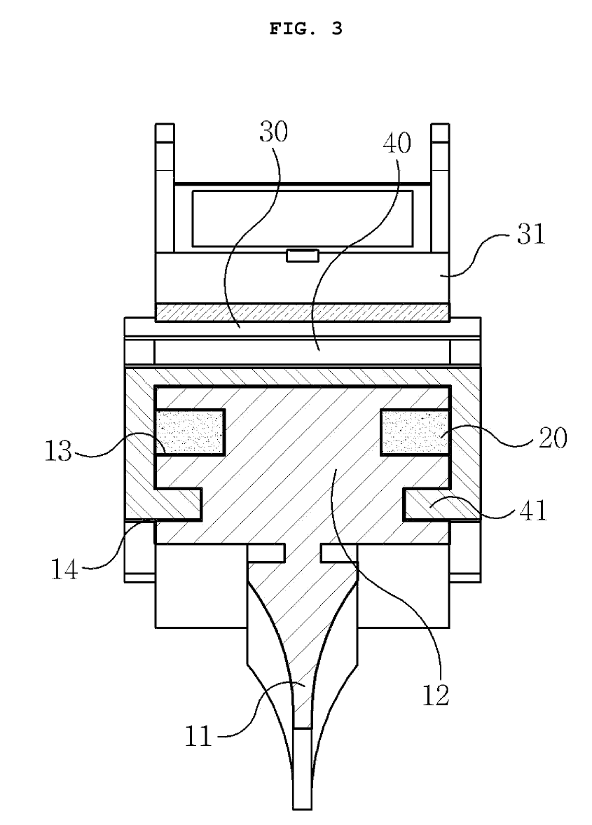

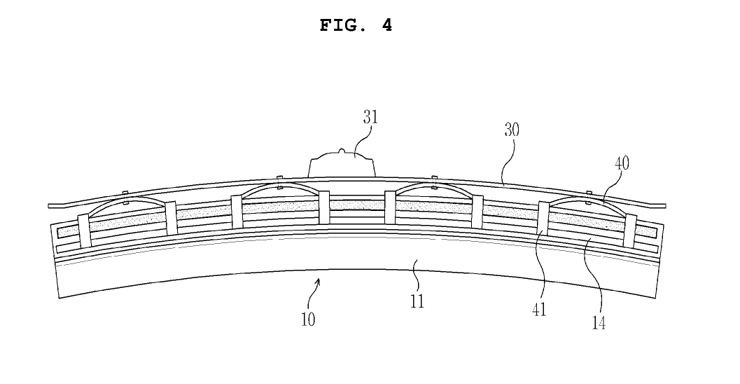

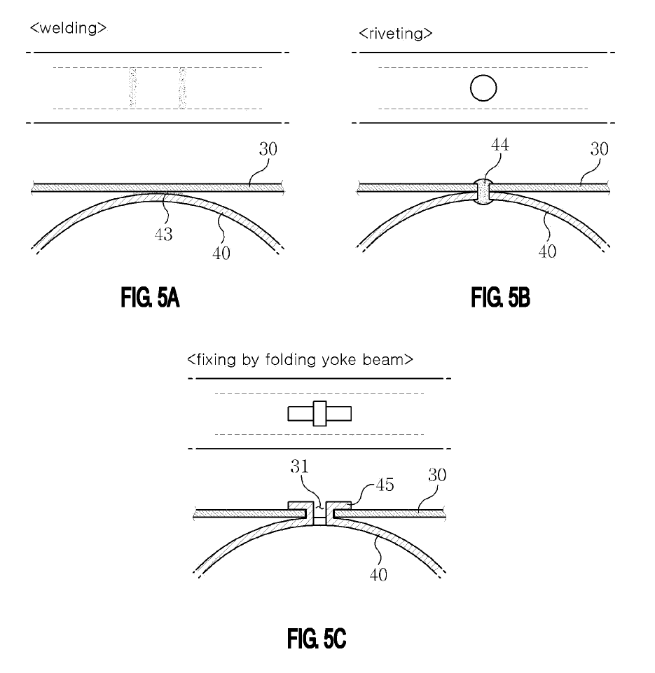

FIG. 1 is an exploded perspective view showing a wiper blade assembly according to the present invention, FIG. 2 is an assembled perspective view showing the wiper blade assembly according to the present invention, FIG. 3 is a sectional view showing the wiper blade assembly according to the present invention, FIG. 4 is a side view showing the wiper blade assembly according to the present invention, and FIGS. 5a to 5c are side views showing examples of the coupling between the auxiliary beam and the guide beam in the wiper blade assembly according to the present invention.

The present invention relates to a wiper blade assembly for wiping a windshield of a vehicle by the activation of a wiper arm, and as shown in FIG. 1, the wiper blade assembly basically includes a wiper blade 10, a pair of rail springs 20, a guide beam 30, and a plurality of auxiliary beams 40.

The wiper blade 10 is adapted to elastically come into close contact with a surface of the vehicle windshield so as to remove the foreign materials accumulated on the vehicle windshield. Further, the wiper blade 10 is flexible and elongated longitudinally. Generally, the wiper blade 10 is made of a rubber material.

The wiper blade 10 includes, as shown in FIG. 1, a body portion 12 and a blade portion 11. The blade portion 11 has a sectional area gradually reduced toward the lower end portion thereof, and the body portion 12 is formed integrally with the blade portion 11 and takes the shape of a generally rectangular parallelepiped.

The body portion 12 has opposite grooves 13, 14 formed longitudinally along the both side surfaces thereof. That is, as shown in FIG. 1, a rail spring-receiving groove 13 and a holding portion-receiving groove 14 are formed at the both side surfaces of the wiper blade 10 along the entire length of the wiper blade 10.

The rail springs 20 are generally made of a metal material, have a given elastic force, and take the shape of an elongated bar. As shown in FIG. 2, the rail springs 20 are disposed in the rail spring-receiving grooves 13 of the wiper blade 10 in such a manner as to be coupled to the wiper blade 10 along the side surfaces of the wiper blade 10. Since the wiper blade 10 is flexible and elongated longitudinally, it is actually difficult to hold the shape of the wiper blade 10, and thus, the formation of the rail springs 20 enables the shape of the wiper blade 10 to be maintained.

The guide beam 30 is mounted over the wiper blade 10 and serves to apply the load and motion applied from a wiper arm (not shown) to the wiper blade 10. The guide beam 30 has a given initial curvature, and if the guide beam 30 is pressed against the surface of the vehicle windshield by means of the load applied from the wiper arm, it exerts a given elastic force therefrom to allow the wiper blade 10 to be pressed against the surface of the vehicle windshield. Generally, the guide beam 30 is formed of a flat spring.

The guide beam 30 is formed of a linear flat spring, as shown in FIG. 1 and has a connector 31 mounted on the central portion thereof. The connector 31 serves to mechanically connect the wiper arm and the guide beam 30, thereby allowing the motions of the wiper arm to be applied to the guide beam 30.

The plurality of auxiliary beams 40 are coupled to the guide beam 30 and are located along a longitudinal direction of the guide beam between the guide beam 30 and the rail springs 20. In the preferred embodiment of the present invention, as shown in FIG. 4, four auxiliary beams 40 are provided, but the number of auxiliary beams 40 is not limited thereto.

In the preferred embodiment of the present invention, the auxiliary beam 40 is made of a metal material and has a given initial curvature providing a given elastic force therefrom. Therefore, the auxiliary beams 40 are mounted between the guide beam 30 and the wiper blade 10, such that the force applied from the guide beam 30 can be distributed to the wiper blade 10 by means of their own elastic forces.

However, the auxiliary beam 40 is not necessarily made of a metal material. The auxiliary beam 40 may be made of a plastic material having a given elastic force. That is, so long as the auxiliary beam 40 has a given elastic force to distribute the force applied from the guide beam 30 uniformly to the wiper blade 10, it does not matter what material the auxiliary beam 40 is made of.

Moreover, although the auxiliary beam 40 does not have any given initial curvature, it does not matter. That is, the auxiliary beam 40 is formed stepped such that it has a given elastic force. In more detail, the auxiliary beam 40 is stepped along both end portions thereof and is extended linearly along the middle portion thereof. In this case, the auxiliary beam 40 has a substantially sufficient elastic force, and therefore, it is not departed from the scope and technical spirit of the present invention.

The auxiliary beam 40 has holding portions 41 formed at both end portions thereof, the holding portions 41 being adapted to fixedly hold the rail springs 20 and the wiper blade 10 together. The holding portions 41 are extended downwardly from each end portion of the auxiliary beam 40 and bent inwardly like a clamp in such a manner as to be located opposite to each other. The bent holding portions 41 are disposed in the holding portion-receiving grooves 14 of the wiper blade 10.

As shown in FIG. 3, the holding portions 41 are received in the holding portion-receiving grooves 14 and coupled to the wiper blade 10 in such a manner as to fully cover the body portion 12 of the wiper blade 10 and the rail springs 20. In the preferred embodiment of the present invention, the guide beam 30 is not mechanically coupled to the wiper blade 10 by means of the direct contacting with the wiper blade 10, but as shown in FIGS. 3 and 4, the guide beam 30 is coupled to the wiper blade 10 by means of the auxiliary beams 40 coupled to the guide beam 30.

The coupling between the auxiliary beams 40 and the guide beam 30 has a variety of methods. FIGS. 1 and 2 show the bolt-coupling method. As shown in FIGS. 5a to 5c, however, welding, riveting, or yoke beam-coupling may be adopted.

In case of the welding as shown in FIG. 5a, there is no need for forming a separate through-hole on the guide beam 30, and contacting portions 43 to be contacted between the auxiliary beam 40 and the guide beam 30 are welded to each other in such a manner as to be face-contacted with each other.

In case of the riveting as shown in FIG. 5b, the through-hole should be formed on the guide beam 30, but the auxiliary beam 40 and the guide beam 30 are coupled simply to each other by means of the riveting 44, thereby enabling a period of time needed for the coupling to be greatly reduced.

In case of the yoke beam-coupling as shown in FIG. 5c, the auxiliary beam 40 is partially incised to form a yoke 45. Then, a through-hole 31 is formed on the guide beam 30 in such a manner as to insert the yoke 45 therethrough. The yoke beam-coupling is rigid and easy.

If the auxiliary beam 40 is made of a plastic material, it further includes an elastic coupling part protruded upwardly and branched radially from the end portion thereof so as to provide a given elastic force therefrom, the elastic coupling part having the upper portion having a larger sectional area than the lower portion thereof, and thus, the auxiliary beam 40 is coupled to the guide beam 30 by means of the formation of the elastic coupling part. In this case, it is easy to mold the plastic auxiliary beam, and the production costs are relatively low, thereby achieving high efficiencies in the production.

Under the above-mentioned configuration of the present invention, the plurality of auxiliary beams 40 that has the given initial curvature providing a given elastic force are located equally along the longitudinal direction of the guide beam 30. In the preferred embodiment of the present invention, each of the auxiliary beams 40 is substantially shorter in length than the guide beam 30, and the four auxiliary beams 40 are spaced equally from each other along the total length of the guide beam 30. However, the number of auxiliary beams 40 is not limited to the scope of this invention, and the auxiliary beams 40 need not be spaced equally from one another.

The auxiliary beams 40 serve to uniformly distribute the load applied from the wiper arm to the entire portion of the wiper blade when the load is applied from the wiper arm to the guide beam 30. Furthermore, since the auxiliary beam 40 is shorter in length than the guide beam 30 and has lower stiffness than the guide beam 30, it has a better capability than the guide beam 30 in accepting and treating the variations of the curvatures of windshield surfaces. The guide beam 30 has high stiffness, but it has a low degree of curvature variation-accepting capability. Thus, if the plurality of auxiliary beams 40 is coupled regularly to the guide beam 30, they serve to reinforce the low degree of curvature variation-accepting capability of the guide beam 30.

As set forth in the foregoing, there is provided a wiper blade assembly having the following advantages:

First, the plurality of auxiliary beams that have a given initial curvature providing a given elastic force are located equally along the longitudinal direction of the guide beam, such that they serve to uniformly distribute the load applied from the wiper arm to the entire portion of the wiper blade when the load is applied from the wiper arm to the guide beam.

Furthermore, since the auxiliary beam is shorter in length than the guide beam and has lower stiffness than the guide beam, it has a better capability than the guide beam in accepting and treating the variations of the curvatures of windshield surfaces. The guide beam has high stiffness, but it has a low degree of curvature variation-accepting capability. Thus, if such the plurality of auxiliary beams is connected regularly to the guide beam, they serve to reinforce the low degree of curvature variation-accepting capability of the guide beam.

Also, the auxiliary beams uniformly distribute the load applied from the wiper arm to the wiper blade, thereby preventing the wiper blade from being partially floated from the surface of the vehicle windshield and allowing the wiper blade to come into close contact with the surface of the vehicle windshield.

When compared with the existing wiper blade assemblies, the present invention can provide relatively high close contacting with the surface of the vehicle windshield, excellent curvature variation-accepting capability, and uniform wiping effects.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A wiper blade assembly for wiping a windshield of a vehicle by the activation of a wiper arm, the wiper blade assembly comprising:
a flexible elongated wiper blade having a given elastic force and adapted to come into direct contact with the windshield of the vehicle;
a pair of rail springs coupled along the sides of the wiper blade so as to maintain the wiper blade in a predetermined shape;
a guide beam coupled to the wiper blade and the rail springs to transfer the load and motion applied from the wiper arm to the wiper blade; and
at least one or more auxiliary beams coupled to the guide beam and located in a longitudinal direction of the guide beam between the guide beam and the rail springs.

2. The wiper blade assembly according to claim 1, wherein each of the auxiliary beams has holding portions formed at the both end portions thereof, the holding portions being adapted to fixedly hold the rail springs and the wiper blade together.

3. The wiper blade assembly according to claim 1, wherein each of the auxiliary beams has a given initial curvature.

4. The wiper blade assembly according to claim 3, wherein each of the auxiliary beams is coupled to the guide beam by means of a bolt, riveting, or welding.

5. The wiper blade assembly according to claim 3, wherein a yoke is formed on the top portion of each auxiliary beam and a coupling hole is formed correspondingly on the guide beam, such that as the yoke is coupled to the coupling hole, the auxiliary beam is coupled to the guide beam.

6. The wiper blade assembly according to claim 1, wherein each of the auxiliary beams is stepped at the both end portions thereof and extended linearly along the middle portion thereof.

7. The wiper blade assembly according to claim 1, wherein each of the auxiliary beams is made of a plastic material.

8. The wiper blade assembly according to claim 7, wherein the auxiliary beam further comprises an elastic coupling part protruded upwardly and branched radially from the end portion thereof so as to provide a given elastic force therefrom, the elastic coupling part having the upper portion having a larger sectional area than the lower portion thereof.

9. The wiper blade assembly according to claim 2, wherein each of the auxiliary beams has a given initial curvature.

10. The wiper blade assembly according to claim 9, wherein each of the auxiliary beams is coupled to the guide beam by means of a bolt, riveting, or welding.

11. The wiper blade assembly according to claim 9, wherein a yoke is formed on the top portion of each auxiliary beam and a coupling hole is formed correspondingly on the guide beam, such that as the yoke is coupled to the coupling hole, the auxiliary beam is coupled to the guide beam.

12. The wiper blade assembly according to claim 2, wherein each of the auxiliary beams is stepped at the both end portions thereof and extended linearly along the middle portion thereof.

13. The wiper blade assembly according to claim 2, wherein each of the auxiliary beams is made of a plastic material.

14. The wiper blade assembly according to claim 13, wherein the auxiliary beam further comprises an elastic coupling part protruded upwardly and branched radially from the end portion thereof so as to provide a given elastic force therefrom, the elastic coupling part having the upper portion having a larger sectional area than the lower portion thereof.
